(19) United States
(12) Patent Application Publication
(10) Pub. No.: US 2009/0148085 A1
(43) Pub. Date: Jun. 11, 2009

(54) Bearings

(75) Inventors: Paul R. Smith, Lincoln (GB); George A. Richardson, Lincoln (GB); Tony Greenwood, Bolton (GB)

Correspondence Address: HANCOCK HUGHEY LLP, P.O. BOX 6553, PORTLAND, OR, 97228, US

(73) Assignees: MINEBEA CO. LTD, Nagano (JP); BELDAM CROSSLEY LTD., Bolton (GB)

(21) Appl. No.: 11/718,600

(22) PCT Filed: Nov. 7, 2005
(86) PCT No.: PCT/GB05/04294

§ 371 Date: Dec. 3, 2008

(30) Foreign Application Priority Data
Nov. 12, 2004 (GB) 0425083.3
Sep. 30, 2005 (GB) 0519964.1

(51) Int. Cl. F16C 33/14; F16C 33/04; B21D 53/10

(52) U.S. Cl. 384/276; 29/898.047

(57) ABSTRACT

According to one aspect of the present invention there is provided a method of manufacturing a bearing comprising the steps of providing a bearing housing incorporating a recess therein, the recess comprising a cup section shaped to receive part of a bearing member and a conforming section, extending from the cup section and incorporating the open end of the recess, the conforming section meeting the cup section at a transition boundary, inserting a pre-formed, continuous, liner through the open end to sit in the recess, the liner being chosen to approximately conform to the initial shape of the recess when inserted therein, inserting a bearing member into the recess through the open end such that the liner is positioned in between the surfaces of the bearing member and recess, deforming the bearing housing in such a way that the recess and liner each conform to the shape of the bearing member and the area of the open end of the recess is reduced in size to prevent removal of the bearing member from the housing during normal use of the bearing.

This invention relates to bearings and, in particular, to the manufacture of self-lubricated spherical bearings.

In order for a particular bearing to operate effectively, it is necessary to provide some form of lubrication between the bearing member and the bearing housing within which the bearing member is seated so as to avoid, as far as possible, progressive wearing and/or damage of the bearing member and bearing housing due to frictional forces.

It is well known to provide a liquid lubricant in the form of a grease between the contacting surfaces of the bearing member and bearing housing. However, the use of grease has several disadvantages, including the need to regularly replenish the lubricant over the life of the bearing in order to avoid excessive wear, with “automatic” replenishment also requiring the provision of a grease reservoir in fluid communication with the bearing surface between the bearing member and the bearing housing. Furthermore, in certain applications, the operating environment of the bearing may have an adverse effect on the performance of a liquid lubricant such as grease. For example, in the case where the bearing is operating within an environment immersed in a fluid, there may be an unsatisfactory degradation in the grease as a result of interaction between the grease and the surrounding fluid.

To overcome the above problems, it is preferable to employ a solid lubricant in the form of a self-lubricating liner disposed between the bearing surface and the bearing housing, self-lubricating liners are formed of a wire mesh material impregnated with a low friction material such as Teflon™, Crossflon™ or the like. The use of such a lubricating liner in so-called “self-lubricating” bearings is well known. Conventionally, one method of forming the liner has been to produce a number of sheet strips of impregnated liner material, which are applied to the bearing surface within the bearing housing to form a hemisphere of liner material. Whilst such a method has proved cost-effective, it does have certain technical drawbacks; most notably, it is difficult to bend the strips into a hemisphere without producing undesirable ripples, creases and wrinkles in the liner surface or gaps between strips of liner, all of which tend to compromise bearing performance.

One technique for forming spherical bearings, which is not best suited for forming lined bearings is that of providing a deformable bearing housing having a substantially hemispherical cup, placing a ball of suitable size within the bearing housing, and then deforming the bearing housing around the ball using a swage to form a finished bearing. Typically, a deformable bearing housing for use in this technique comprises a generally annular ring, which displays approximately circular symmetry around a central axis. The inner surface of the ring comprises a counterface portion in the form of a hemispherical cup, which is shaped to receive and closely fit against the surface of a ball placed in the bearing housing, and upstanding wall portion, which is substantially perpendicular to the central axis and allows the placement of the ball in the bearing housing to rest prior to deformation of the bearing housing. The hemispherical shape of the cup allows the counterface portion to lie against the lower half of the ball, up to and including the circumference of the ball taken in a plane perpendicular to the central axis and passing through the centre of the ball.

Such a method is not best suited to forming self-lubricating, lined bearings employing conventional “strip”-formed liners because, separate from any rippling or creasing which occurs as a result of initial application of the strips, when the bearing housing is deformed using the swage, the strips of self-lubricating liner tend to be stretched, creased or wrinkled as a result of the various compression and tension forces acting across the bearing surface during swaging. Indeed, with a conventional liner as described above, the degree of wrinkling and creasing, or the gaps created between strips of liner material, is such that the lubricating performance of the liner is unsatisfactorily compromised.

One method which has been developed in an attempt to reduce the problem of rippling and overlap of the self-lubricating liner, both upon application of the liner material to the bearing surface of the bearing housing and during the swaging process, involves producing the self-lubricating liner in the form of a flat net, incorporating a number of flap portions and darts. The net is designed so that, as far as possible, it can be bent or folded into a three dimensional liner having a surface which conforms closely to the bearing surface of a given bearing housing to be lined. However, it will be appreciated that the mapping of a flat piece of liner material onto a curved bearing surface can often only be achieved using a very complicated net for the liner, incorporating a number of complex flaps, darts and angled edges. The production of such a complicated net is very difficult and, indeed, in practice it has proved very difficult to produce a net which, when constructed in three dimensions, closely conforms to the bearing surface of a given bearing housing. As a result, when the net is constructed in three dimensions and the resulting three dimensional liner is placed within a given bearing housing, there are inevitably a number of gaps (caused by inaccuracies in the position and/or angle of darts included in the original net) and areas where the liner is creased or has been “doubled up” in thickness (due to inaccuracies in the size and position of one or more flaps in the original liner net). Such gaps, creases and areas of “doubled up” thickness result in the performance of the bearing being unsatisfactorily compromised.

A further disadvantage of conventional swaging techniques is that, when the wall portion is swaged around the bearing with a swage, the part of the inner surface at the junction of the cup and the wall portion, as well as other parts of the inner surface of the ball housing, press excessively tightly against the surface of the ball, thereby “pinching”, and possibly deforming, the ball with the result that movement of the ball is restricted, leading to an unpredictable torque in the finished bearing.

Known techniques for attempting to alleviate the problem of “pinching” rely on forming the bearing housing so that the wall portion deforms more readily than the cup area so that the cup area is not stressed. For instance, it is known to leave additional thickness of material around an outer surface of the bearing housing in the vicinity of the cup area to strengthen this part of the bearing housing. Alternatively, it is know to remove material from the outer surface of the bearing housing in the vicinity of the wall portion, thereby making the wall portion less robust and more susceptible to deformation. However, the techniques suffer from the drawback of either making the bearing housing unnecessarily heavy, bulky and therefore expensive, or weakening a part of the housing bearing, leading to an increased likelihood of damage or failure. The disadvantages of excessive bulk and likelihood of failure is particularly serious in suspension systems, in which bearings in the form of ballpin joints are normally employed, as these systems often need to be both light and hard wearing, for example in the case of automobile suspension systems.

As a result of the disadvantages of using swaging techniques in the manufacture of lined, self-lubricating bearings, such bearings have tended to be manufactured by machining unique bearing housings and bearing members which co-operate with one another, the bearing member being retained within the bearing housing by means of a suitably configured retaining member, usually in the form of an annular retaining ring held in position at the entrance to the recess in the bearing housing by staking a portion of the rim of the bearing housing, so as to firmly hold the bearing member within the bearing housing. The need to manufacture separate components, such as a retaining member in the form of an annular ring, as well as the additional steps required to fix the retaining member in place, inevitably add to the manufacturing cost of the bearing.

It is an object of the present invention to seek to provide an improved bearing and an improved method of manufacturing a bearing.

Accordingly, one aspect of the present invention provides a pre-formed, self-lubricating, self-supporting, continuous, liner for insertion into a bearing housing to be swaged, the liner comprising a cup portion and a circumferential wall portion extending upwardly from the cup portion such that, post-swaging of the housing, the cup portion and wall portion together conform closely to the bearing surface of the bearing and define a continuous liner surface.

Another aspect of the present invention provides a method of forming a self-lubricating, self-supporting, continuous bearing liner for a given bearing, comprising: providing an open-ended conical member formed from a lubricating material; moulding the member so as to closely conform to the bearing surface of an unswaged bearing housing to be lined.

Another aspect of the present invention provides a method of forming a self-lubricating, self-supporting, continuous bearing liner for a bearing, comprising: providing an open-ended conical member formed from a mesh material; providing an open-ended conical member formed from a lubricating material; placing one conical member at least partially within the other conical member; exposing the members to a pressure sufficient to force them against one another such that the lubricating material impregnates the mesh material; and moulding the members so as to closely conform to the bearing surface of an unswaged bearing housing to be lined.

Another aspect of the present invention provides a method of manufacturing a bearing comprising: providing a bearing housing incorporating a recess therein, the recess comprising a cup section shaped to receive part of a bearing member and a conforming section, extending from the cup section and incorporating the open end of the recess, the conforming section meeting the cup section at a transition boundary; inserting a pre-formed, self-lubricating, self-supporting, continuous, liner through the open end to sit in the recess, the liner being chosen to approximately conform to the initial shape of the recess when inserted therein; inserting a bearing member into the recess through the open end such that the liner is positioned inbetween the surfaces of the bearing member and recess; swaging the bearing housing in such a way that the recess and liner each conform to the shape of the bearing member and the area of the open end of the recess is reduced in size to prevent removal of the bearing member from the housing during normal use of the bearing.

Another aspect of the present invention provides a self-lubricating bearing comprising a bearing housing incorporating a recess formed therein, a bearing member seated within the recess, and a pre-formed, self-lubricating, self-supporting, continuous liner positioned inbetween the bearing member and the bearing housing, wherein the recess and liner conform closely to the shape of the bearing member in such a way as to prevent removal of the bearing member from the recess.

The present invention provides a pre-formed, self-lubricating, self-supporting, continuous, liner, and a method of forming the liner, as defined by the claims, with reference to the description and drawings.

The present invention provides a bearing, and a method of manufacturing a bearing, as defined by the claims, with reference to the description and drawings.

In order that the present invention may be more readily understood, embodiments thereof will now be described by way of example, with reference to the accompanying drawings, in which:

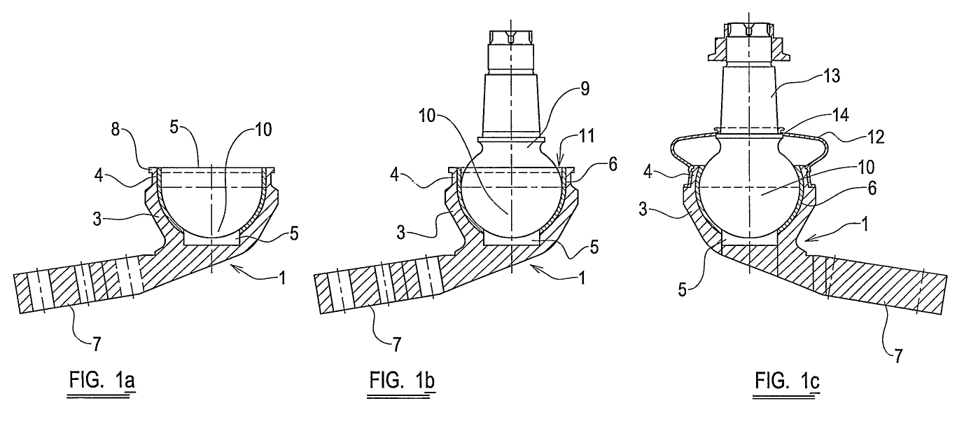

FIGS. 1A, 1B and 1C show a cross-section through a bearing according to the present invention at various stages of the method of manufacturing a bearing according to the present invention;

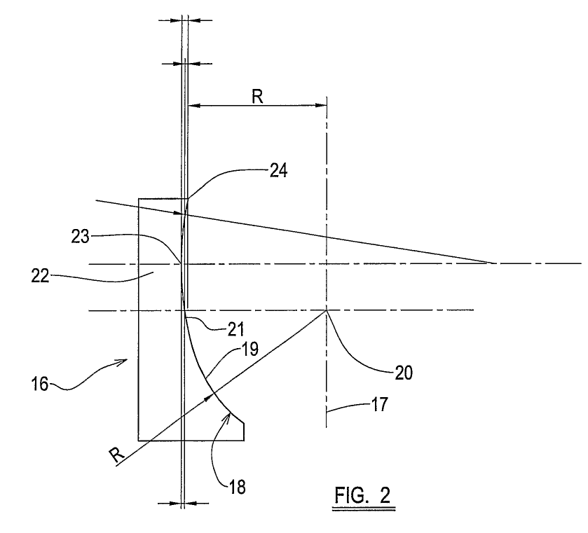

FIG. 2 shows a partial cross-sectional view of a preferred form of bearing housing for use in a method of manufacturing a bearing according to the present invention.

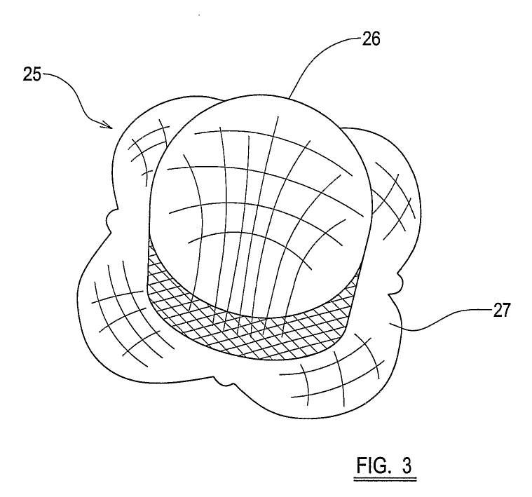

FIG. 3 shows a schematic perspective view of a generally cup-shaped portion of mesh formed in accordance with a preliminary step in a method of manufacturing a self-lubricating liner according to the present invention;

FIG. 4 shows a schematic perspective view of a cup-shaped mesh member formed from the cup-shaped portion of FIG. 3;

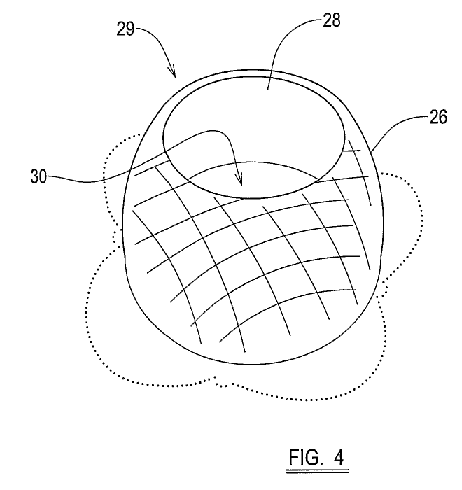

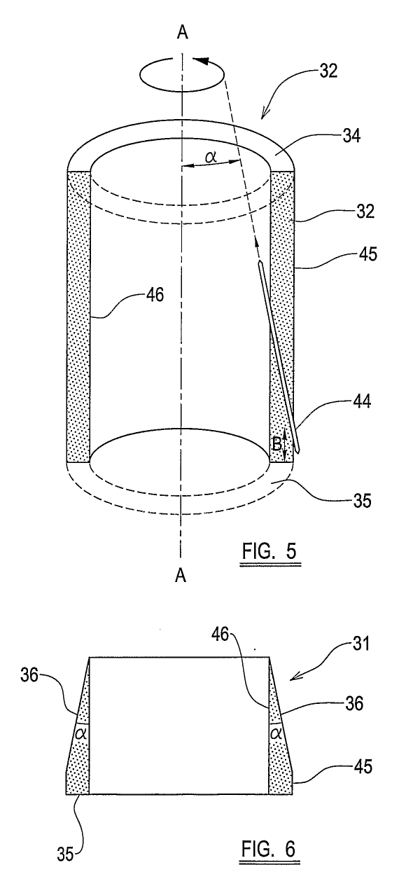

FIG. 5 shows a schematic view, partly in cross-section and partly in phantom, of a tube of impregnating material created in accordance with a method of forming a self-lubricating liner according to the present invention;

FIG. 6 shows a cross-sectional view of a conical member cut from the tube of FIG. 5;

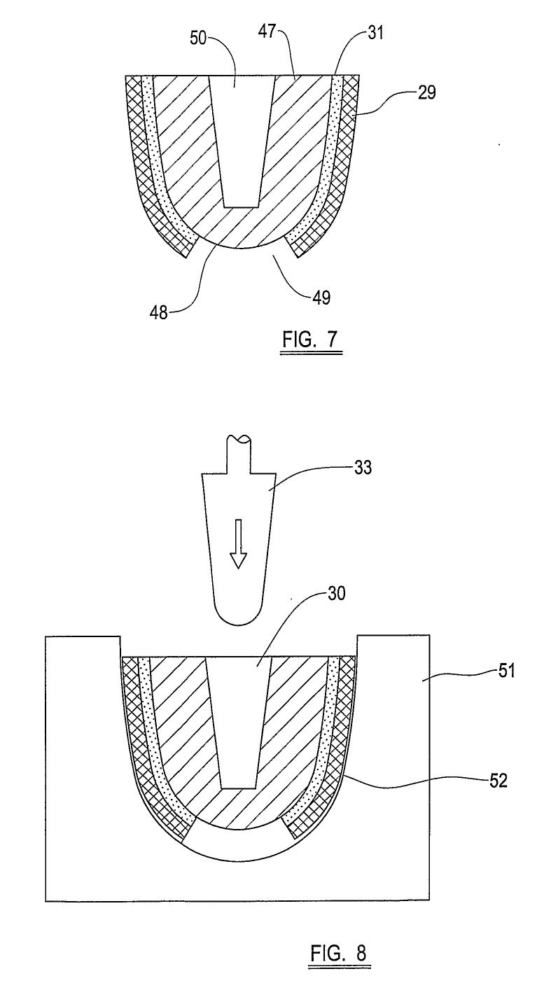

FIG. 7 shows a schematic cross-sectional view illustrating the conical member of FIG. 6 stretched over a male mould portion and placed within the cup-shaped member of FIG. 4.

FIG. 8 a schematic cross-sectional view illustrating the conical member and cup-shaped member in a mould prior to moulding;

FIG. 9 shows a schematic cross-sectional view corresponding to FIG. 8, during moulding of the conical and cup-shaped members; and

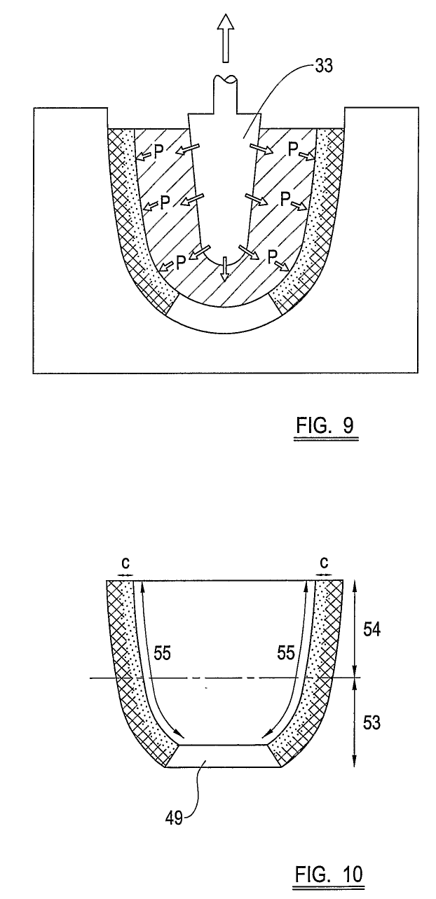

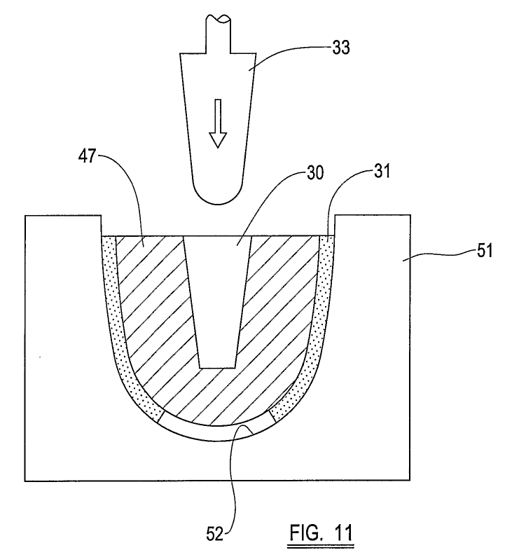

FIG. 10 shows a cross-section through a self-lubricating liner formed by a method of manufacturing a self-lubricating liner according to the present invention;

FIG. 11 shows a schematic cross-sectional view illustrating the conical member of another embodiment in a mould prior to moulding.

FIGS. 1A, 1B & 1C show a general overview of the method of manufacture of a self-lubricating bearing embodying the present invention. Referring specifically to FIG. 1A, a bearing housing 1 is provided incorporating a recess 2 comprising a cup section 3 shaped to receive part of a bearing member, a conforming section 4 in the form of a circumferential wall extending from the cup section and incorporating the open end 5 of the recess 2, and a cylindrical sump 15 spanning the base of the cup section 3.

A pre-formed, self-lubricating, self-supporting, continuous, liner 6 is disposed in the recess 2, the liner 6 having been formed to conform with the initial shape of the cup section 3 and conforming section 4 of the recess 2. In the example shown in FIG. 1A, the self-lubricating liner 6 is shown as conforming very closely to the inner surface of the recess 2; however, it is to be appreciated that such a close degree of conformity need not exist, provided that the self-lubricating liner 6 approximately conforms to the inner surface of the recess 2. In any event, it is to be noted that the liner has an open end which does not span the sump 15, for reasons described below.

In the example shown in FIG. 1A, the bearing housing 1 incorporates an integral arm 7, extending, in this particular example, away from the portion of the housing 1 incorporating the recess 2, and which may be used to mount the bearing housing during operation.

The bearing housing 1 is preferably formed of a metal such as steel, and may be machined using conventional techniques, as will be readily understood by the person skilled in the art. Preferably, the bearing housing incorporates a lip 8 around the rim of the open end 5 of the recess 2, the function of which is described below.

Turning now to FIG. 1B, which shows an intermediate stage of the manufacturing process, it can be seen that a bearing member, in this case in the form of a ballpin 9, has been inserted through the open end 5 of the recess 2 and seated within the recess 2 so as to sandwich the liner 6 between a ball 10 of the ballpin 9 and the inner surface of the recess 2. It will be appreciated that, due to the relative geometry of the ball portion 10 and recess 2, an annular space, indicated at 11, will exist between the ball 10 and the conforming portion 4 of the housing 1. In addition, it will further be appreciated that a gap exists between the ball 10 and the walls of the sump 15. It should be noted that the step of seating the ball 10 in the recess 2 will serve to conform the shape of the liner 6 more closely to the shape of the recess 2.

FIG. 1C shows the finished configuration of the bearing, after swaging of the bearing housing. It can be seen that the swaging of the conforming portion 4 of the bearing housing 1 has closed the space 11 (FIG. 1B) so that the liner 6 and the conforming portion 4 now each closely conform to the shape of the ball portion 10 of the ballpin 9. Furthermore, it will be appreciated that deformation of the conforming portion 4 and the liner 6 has reduced the area of the open end 5 of the recess 2 (see FIG. 1A), with the result that removal of the ball 10, and hence the entire ballpin 9, through the open end of the recess 2 is prevented, at least during normal operation of the bearing.

A cover sleeve or seal 12 may be fitted to the housing and stand portion 13 of the ballpin 9 to prevent contamination of the bearing surfaces which may compromise the operational performance of the bearing. In the present example, the cover sleeve 12 is constructed from a resilient, preferably rubber, material which grips the stem 13 and the conforming portion 4 in a friction fit. Retention of the cover sleeve 12 is aided by the lip portion 8, as well as a flange portion 14 located on the stem 13.

It will be appreciated, from FIGS. 1A to 1C, that the principal area of deformation of the housing occurs above the equator of the ball portion 10; that is to say, deformation principally occurs within the conforming portion 4 of the bearing housing, rather than the cup portion 3. The cup portion 3 need not and should not itself be swaged because, on the one hand, the liner 6 has been pre-formed so as to approximately conform to the initial shape of the recess even prior to insertion of the bearing member (i.e. ballpin 9) whilst, on the other hand, the cup portion does not extend above the equator of the ball portion 10 so that swaging of the cup portion 3 is not required in order to retain the ball portion 10 within the recess 2.

Moreover, whilst deformation of the conforming portion inevitably occurs as a consequence of the swaging process, it will be noted that the conforming portion 4 represents only a small portion of the recess 2, and hence corresponds to only a small area of the bearing surface between the ball portion 10 and recess 2, with the result that any rippling, creasing or wrinkling produced within the area of the liner 6 adjacent the conforming portion 4 is confined to only a very minor portion of the bearing surface.

In any event, it will be appreciated that, because the liner is in the form of an integral, pre-formed liner, no gaps will occur in the liner across the conforming portion 4 of the bearing housing 1.

FIG. 2 shows another embodiment of the bearing housing which may be substituted for bearing housing 1, and which addresses the problem of “pinching” of the bearing member by the bearing housing during the swaging process.

Referring to FIG. 2 the alternative bearing housing 16 is generally of a ring shape (in the same sense as bearing housing 1) and has at least approximately circular symmetry about the central axis 17 thereof.

The inner surface 18 of the bearing housing 16 comprises a cup section 19, each point of which lies at least approximately at a distance R from a centre point 20, which distance R corresponds to the radius of the bearing member to be inserted into the bearing housing 16. In contrast with the bearing housing 1 shown in FIGS. 1A to 1C, the cup section 19 of the bearing housing 16 does not extend as far as the plane that is perpendicular to the central axis 17 and passes through the centre point 20 (i.e. the equatorial plane of a bearing member inserted into the housing). Rather, the cup section 19 ends at a transition boundary 21 (which transition boundary, it will be appreciated, forms a continuous ring around the inner surface of the bearing housing recess) so that the cup section 19 of the bearing housing 16 contacts less of the surface of a bearing member placed therein than does the corresponding cup section 3 of the bearing housing 1 of FIGS. 1A to 1C. Above the transition boundary, the bearing housing 16 comprises a conforming section 22, the inner surface of which lies at a distance greater than R from the centre point 20.

It will be appreciated, from FIG. 2, that, when a bearing member, having radius R, is inserted into the housing 16, a clearance gap will exist between the bearing member and the conforming section 22 immediately adjacent the transition boundary, the clearance gap being larger than any clearance between the cup section 19 and the bearing member.

Above the transition boundary, the inner surface of the conforming portion describes a smooth arc, which reaches a far point 23, at which the distance of the inner surface of the conforming section 22 from the central axis 17 is greatest, before curving back in towards the central axis 17 to an end point 24. This smooth arc meets the cup section 19, at the transition boundary 21, at a tangent to the radius of the cup section 19, so that the entire inner surface 18 of the bearing housing 16 is comprised of a series of arcs with smooth transitions between the radii of the arcs so as to be substantially free of discontinuities. The distance of the end point 24 from the central axis 17 is preferably substantially equal to R, and it will be appreciated that this arrangement allows the insertion of a ball having radius R into the bearing housing 16 prior to swaging thereof.

When a ball having radius R is inserted into the bearing housing 16 and the bearing housing 16 is deformed around the ball by use of a swage, it has been found that the configuration of the inner surface 18 of the bearing housing 16 substantially reduces or eliminates “pinching” of the bearing i.e. bearing housing 16.

It will be appreciated that, although in the preferred embodiment shown the conforming section 23 presents a continuous concave bearing surface, the actual form of the bearing surface presented by the conforming section 23 can be varied in a great number of ways, provided that the clearance gap exists, as hereinbefore described, between the conforming section and bearing member (when the bearing member has been inserted into the bearing housing 16) immediately adjacent the transition boundary 21.

It will be appreciated that the bearing housing 16 is readily interchangeable with the bearing housing 1 in the method of the present invention, it merely being necessary to mould the pre-formed, self-lubricating, continuous, liner so that it conforms closely to the curved inner surface 18. Furthermore, it will be appreciated that the bearing housing 16 may incorporate a sump similar to sump box section 15 (see FIGS. 1A, 1B and 1C).

In addition to the advantages described above, it will be appreciated that, after swaging the bearing housings 1 or 16, no separate retaining member is needed to retain the bearing member within the bearing housing during use, this retaining action being pre-formed by the swaged conforming portion of the bearing housing and resulting reduction in the area of the open end of the bearing housing. Thus, the number of independent components in the finished bearing is reduced as compared to conventional bearings previously described, with the result that the manufacturing cost of the bearings embodying to the present invention tends to be reduced as compared to conventional machining processes.

Turning now to FIGS. 3 to 10, a method of preforming the self-lubricating, self-supporting, continuous liner 6 will now be described.

FIGS. 3 to 10 represent a very simple, schematic representation of a method of preforming the self-lubricating, self-supporting, continuous liner embodying the present invention.

Referring to FIG. 3, a sheet of mesh material 25 such as, for example phosphor bronze or stainless steel is initially stamped or otherwise moulded to form a preliminary cup-shaped portion 26 extending from planar flange portion 27, and then subsequently stamped further to form a hole 28 in the upper part of the cup portion 26 and to remove planar flange portion 27 (see FIG. 4). Thus, an open ended cup-shaped member 29 is formed from the mesh material incorporating the hole 38 opposite the open end 30.

In addition to the formation of the above mentioned cup-shaped mesh member 29, a separate, open ended, conical member 31 (see FIG. 6) is also formed, from an impregnating material such as, for example, a PTFE material, in particular Crossflon™.

Referring to FIG. 5, the conical member 31 is formed by initially preparing the require formulation of impregnating material, in a conventional manner, and then subsequently forming a tube 32 of the impregnating material incorporating a circumferential wall 33 defining an annular top surface 34 and annular base surface 35. The tube 38 may be formed in any conventional manner and, in particular, may be formed by injection moulding under a suitable pressure and temperature.

As indicated schematically in FIG. 5, the tube 32 is mounted for rotation about its longitudinal axis A in conventional manner such as, for example, by means of mounting upon a rotating support plate at one or both ends (not shown).

In order to form the conical surface 36 of the conical member 31 (see FIG. 6), the blade 44 of a conventional cutting machine (not shown) is advanced through the wall 33 of the tube 32 such that it cuts through both the outer circumferential surface 45 and inner circumferential surface 46 of the wall 33 of the tube 32 at an acute angle α, as shown in FIG. 5. It will be immediately appreciated that the combination of rotating the tube 32 about the axis A and cutting action of the blade 44 at an angle α to the axis A will result in the blade 44 tracing a conical cutting surface i.e. a cutting surface defining at least a portion of a cone, in this case, a frusto conical surface, centred about the axis of rotation A and intersecting the outer circumferential surface 45 and inner circumferential surface 46 at an angle α.

Referring to FIG. 6, the conical member 31 is defined by conical surface 36 (corresponding to the frusto conical cutting surface traced by the blade 44 during cutting), the outer circumferential surface 45, inner circumferential surface 46 and base surface 35.

It will be appreciated that the final form of the conical member 31 depends upon the thickness of the circumferential wall 32, as well as the angle a and the distance B (see FIG. 5) between the base surface 35 and point of entry of the blade 44 through the outer circumferential surface 45. Thus, by closely controlling the geometry of the tube 32 and cutting position of the blade 44, the particular geometry of the conical member 45 can be precisely controlled and varied as desired. In particular, by forming the tube 32 with a very restricted central bore i.e. with the diameter of the inner circumferential surface 46 being much smaller than the diameter of the circumferential outer surface 45, the conical surface 36 can be formed to very nearly approximate a “true” conical surface (as opposed to a frusto conical surface).

Once the conical member 31 has been formed, it is then stretched over a male mould portion which, in the preferred embodiment, is in the form of a first resiliently deformable mandrel 47 (see FIG. 7). The mandrel 47 has a cup-shaped moulding surface 48 which conforms closely to the cup-shaped member 29, so that once the conical member 31 has been stretched over the moulding surface 48 of the mandrel 47, the external surface of the conical member 31 also closely conforms to the cup-shaped mesh member 29, as shown in FIG. 7. In the present preferred embodiment, where the conical surface 36 is frusto conical, the conical member 31 will not entirely cover the moulding surface 48 of the mandrel 47, but rather a gap 49 will exist at the base of the moulding surface 48, coinciding with the location of the hole 28 in the cup-shaped mesh member 29. It will be appreciated that, by varying the precise shape of the conical member 31 as described above, and varying size of the hole 28, the gap 49 can be made coincidental with the width of the sump 15 of the bearing housing 1 (see FIGS. 1A, 1B, 1C). Moreover, by precisely controlling the shape of the conical member 31 in the manner described above, it is possible to ensure a good fit between the (stretched) conical member 1 and the mandrel 47.

The mandrel 47 is also provided with an axial recess, preferably in the form of a frusto conical recess 50 extending downwardly through the mandrel 47.

Referring now to FIG. 8, the cup-shaped mesh member 29, stretched conical member 31 and mandrel 47 are all placed into a female mould portion 51 having a moulding surface 52 closely conforming to the bearing surface of the particular bearing housing to be lined (which, in the example shown in FIG. 8 is the inner surface of recess 2 in FIG. 1A). A second mandrel 53 is aligned directly above the recess 50 and arranged for a downward driving movement as indicated by the arrow in FIG. 8. The mandrel 53 is configured so that it is too large to fit into recess 50 without resilient expansion of the walls of the recess 50.

As shown in FIG. 9, when the mandrel 53 is driven downwardly into the recess 50, it presses outwardly against the walls of the recess 50, (due to the dimensions of the mandrel 53) thus causing a resilient expansion of the recess 30 and consequently resiliently biasing the moulding surface 48 of the resilient first mandrel 47 against the conical member 31 and towards the cup-shaped member 29 and female mould portion 51, thereby exerting a pressure P on the conical member 31 and cup-shaped mesh member 29 (as illustrated by the arrows in FIG. 9). The relative dimensions of the recess 50 and second mandrel 53 are specifically chosen so that the biasing pressure P is sufficiently high to cause the impregnating material forming the conical member 31 to impregnate the interstitial spaces of the mesh of the cup-shaped member 29, as indicate schematically in FIG. 9. At the same time, the resilient biasing action of the mandrel 47 acts to sandwich the conical member 31 and cup-shaped member 29 between the mandrel 47 and moulding surface 52 of the female mould portion 51, thereby moulding the conical member and mesh member to the shape of the moulding surface 52.

It will be appreciated, from FIG. 9, that as the conical member 31 impregnates the cup-shaped mesh member 29, the effective width of the resulting composite member will progressively decrease. Nevertheless, provided appropriate dimensions for the mandrel 53 and recess 50 are chosen, the resilient biasing action of the mandrel 47 towards the female portion 51 will ensure that the composite member remains sandwiched between the mandrel 47 and female mould portion 51, resulting in a sustained impregnation and moulding of the mesh member 29.

Once the conical member 31 has sufficiently impregnated the mesh member 29, the mandrel 53 may be withdrawn from the mandrel 47, as indicated by the arrow in FIG. 9, and the mandrel 47 can then be withdrawn from the mould to leave the resulting liner 6 (see FIG. 9).

Referring specifically to FIG. 10, the final structure of the liner 6 is shown in cross-section. Thus, the liner 6 is formed of impregnated mesh material and comprises a cup portion 53 and a circumferential wall portion 54 extending upwardly from the cup portion 53 such that the cup portion and wall portion together conform closely to the bearing surface of the bearing housing 1 and define a continuous liner surface 55. The liner surface is continuous in the sense that it does not incorporate any gaps in the liner surface or any substantial overlapping of the liner upon itself—which discontinuities can present themselves as sharp changes in the thickness of the liner surface or, indeed, total absence of liner. There may be some level of overlap in the resultant liner but the degree of overlap is far less than is the case for the conventional strip formed liners discussed beforehand. As shown in FIG. 9, the impregnated lubricating material, such as Crossflon™, impregnates the mesh material of the cup shaped mesh member 29 to a depth C which, in the preferred embodiment, corresponds to a depth of approximately two thirds of the final liner.

Although, in the present embodiment, the female mould portion 51 is configured to produce a liner 6 conforming to the bearing surface of bearing housing 1, it will nevertheless be appreciated that the final form of the liner can be varied to suit a given bearing housing to be lined, merely by appropriately configuring the moulding surface of female mould portion 51. In particular, it will be appreciated that, by modifying the moulding surface of the female mould portion 51, a liner can be produced which comprises a wall portion which is itself concave such that wall portion and cup portion together conform to the inner surface 18 of the bearing housing 16.

Although it is possible, using the present method, to produce a liner conforming closely to a given bearing housing to be lined, it is envisaged that, in a further preferred embodiment, the liner may be finally trimmed, in particular the wall portion of the liner, to ensure a closer fit to the bearing surface of the bearing housing to be lined.

Optionally, the liner may be etched upon its outer surface to aid formation of a better bond between the liner and bearing housing in the case where the liner is bonded to the bearing housing using an adhesive and the adhesive is applied to the outer surface of the liner.

In another embodiment, the bearing housing 1 may be formed without a sump 15, in which case the conical member 31 must be formed so that the conical surface 36 is very nearly “truly” conical, thus avoiding formation of the opening 48 as the conical member 31 is stretched over the mandrel 47. Although, in the present method, there exists an inevitable “trade-off” between forming a near “true” conical (as opposed to frusto conical) surface 36 and, on the other hand, ensuring that the open end of the conical member 31 (defined by the diameter of circumferential surface 46) is sufficiently large to allow stretching of the conical member 3 over the mandrel 47, it will be quickly appreciated by the skilled person that it is nevertheless possible to achieve a sufficient “balance” between these factors, so as to enable a reduction in size of any such opening in the liner so that bearing performance is not unduly compromised.

Whilst in the example described above, the mesh member 29 has been described as being provided in a cup-shape, it is also possible for the mesh member to be provided as a conical member, in a very similar way to that of the conical lubricating member.

In a method of manufacturing such a liner according to this embodiment, the conical lubricating member 31 is stretched over the male mould portion 47 as described above. The conical mesh member is then stretched, in turn, over the lubricating member already loaded onto the male mould portion 47. As before, the mould portion 47 is then driven into a female mould portion 51 to form a self-lubricating continuous liner. It will be appreciated that the impregnating of the lubricating member into the mesh member will occur in exactly the same way as herein before described when the mesh member is cup-shaped.

In another example of the invention, the self-lubricating, continuous bearing liner comprises only the lubricating member—i.e. with no mesh member provided.

The method of forming the liner without the mesh member is substantially the same as the method hereinbefore described for the lubricating and mesh member composite liner. That is to say, with reference to FIG. 11, an open ended conical lubricating member 31 is formed as shown in FIGS. 5 and 6 (and as described in the accompanying passage of description. The conical lubricating member 31 is then stretched over the male mould portion 47 as hereinbefore described. The male mould portion 47 and stretched conical lubricating member 31 are then placed into a female mould portion 51 as before.

A second mandrel 33 is then aligned directly above a recess 50 of the male mould portion 57 and arranged for a downward driving movement as shown in FIG. 11.

As the second mandrel 33 is driven into recess 50, the liner is moulded to conform to the shape of the moulding surface 52.

This example, i.e. without a mesh member, is particularly advantageous in some situations in that it requires fewer parts and a less complex manufacturing method. It is particularly suitable for applications where bearing degradation is relatively low. However, for more heavy duty applications, the composite mesh and lubricating member liner may be more suitable.

In any event, it will be appreciated that all of the methods embodying the present invention hereinbefore described conveniently provide a self-lubricating, self-supporting, continuous, bearing liner for a given bearing. Importantly, in all examples of the invention, the liner surface is continuous in the sense that it does not incorporate any gaps in the liner surface or any substantial overlapping of the liner upon itself—which discontinuities can present themselves as sharp changes in the thickness of the liner surface or, indeed, total absence of liner. There may be some level of overlap in the resultant liner but the degree of overlap is far less than is the case for the conventional strip formed liners discussed beforehand.

Also important is that in all embodiments of the invention, the liner is self-supporting. In self-supporting is meant that the liner can maintain its shape and structure without need for support means external to the liner. Thus, even when not inserted in the bearing housing (where it would then rest against and be supported by the bearing surface of the housing), the liner in isolation will still support itself and comprise a cup portion and circumferential wall portion extending upwardly from the cup portion.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A pre-formed, self-lubricating, self-supporting and continuous liner for insertion into a bearing housing to be swaged, the liner comprising a cup portion and a circumferential wall portion extending upwardly from the cup portion such that, post-swaging of the housing, the cup portion and wall portion together conform closely to the bearing surface of the bearing and define a continuous liner surface.

2. A liner according to claim 1, wherein the liner is formed from a lubricating material.

3. A liner according to claim 1, wherein the liner is formed from a mesh material.

4. A liner according to claim 3, wherein the mesh material is impregnated with the lubricating material.

5. A method of forming a self-lubricating, self-supporting and continuous bearing liner for a given bearing, comprising: providing an open-ended conical member formed from a lubricating material; moulding the member so as to closely conform to the bearing surface of an unswaged bearing housing to be lined.

6. A method according to claim 5, further comprising: providing a mould comprising a female mould portion having a moulding surface closely conforming to the bearing surface of the unswaged bearing housing to be lined, and a male mould portion; stretching the conical member over a moulding surface of the male mould;
pressing the moulding surface of the male mould portion towards the moulding surface of the female mould portion, thereby moulding the conical member.

7. A method of forming a self-lubricating, self-supporting and continuous bearing liner for a bearing, comprising: providing an open-ended conical member formed from a mesh material; providing an open-ended conical member formed from a lubricating material; placing one conical member at least partially within the other conical member; exposing the members to a pressure sufficient to force them against one another such that the lubricating material impregnates the mesh material; and moulding the members so as to closely conform to the bearing surface of an unswaged bearing housing to be lined.

8. A method according to claim 7, further comprising:
providing a mould comprising a female mould portion having a moulding surface closely conforming to the bearing surface of the bearing housing to be lined, and a male mould portion;
stretching the conical lubricating member over a moulding surface of the male mould portion prior to placing the conical lubricating member within the conical mesh member;
pressing the moulding surface of the male mould portion towards the moulding surface of the female mould portion, thereby moulding the conical members therebetween and exposing the members to sufficient pressure to cause said impregnation.

9. A method according to claim 7, wherein the conical mesh member is formed in one piece by mechanical stamping from sheet mesh material.

10. A method according to claim 9, wherein, after stamping, the conical mesh member is also mechanically trimmed.

11. A method according to claim 7, wherein the members are exposed to a pressure sufficient to cause impregnation of the mesh up to a depth of two-thirds of the mesh thickness.

12. A method according to claim 7, wherein the conical mesh member is cup-shaped.

13. A method according to claim 7, wherein the conical lubricating member is formed by machine-cutting a tube of said lubricating material.

14. A method according to claim 13, wherein the conical surface of the conical member is formed by:
advancing a blade through the wall of the tube at an acute angle to the axis of the tube such that the blade cuts through both the outer and inner circumferential surfaces of the tube wall; and
rotating the tube about its axis such that the blade traces a conical cutting surface centered about the axis of rotation and intersecting the outer and inner circumferential surfaces of the tube wall.

15. A method according to claim 6 or 8, wherein the male mould portion is in the form of a first resiliency deformable mandrel incorporating an axial recess and having a moulding surface shaped to conform to the bearing surface of the unswaged bearing housing to be lined, a second mandrel further being provided for driving into said recess so as to press outwardly against the walls of the recess and resiliently expand the recess, thereby resiliently biasing the moulding surface of the first mandrel towards the female mould portion.

16. A method according to claim 5 or 7, wherein the or at least one conical member is in the form of a frusto-conical member, open at each end.

17. A method according to claim 1, wherein the resulting structure is mechanically trimmed to size.

18. A liner according to claim 2, wherein the lubricating material is PTFE.

19. A liner according to claim 3, wherein the mesh is formed from phosphor bronze.

20. A liner according to claim 3, wherein the mesh is formed from stainless steel.

21. A method according to claim 15, wherein the first mandrel is formed from PEEK.

22. A method according to claim 1, wherein the resultant pre-formed, self-lubricating, self-supporting, continuous bearing liner comprises a cup portion and a circumferential wall portion extending upwardly from the cup portion.

23. A method according to claim 22, wherein the wall portion defines a substantially vertical portion of the liner surface.

24. A method according to claim 22, wherein the wall portion defines a concave liner surface portion.

25. A method of manufacturing a bearing comprising:
providing a bearing housing incorporating a recess therein, the recess comprising a cup section shaped to receive part of a bearing member and a conforming section, extending from the cup section and incorporating the open end of the recess, the conforming section meeting the cup section at a transition boundary;
inserting a pre-formed, self-lubricating, self-supporting, continuous, liner through the open end to sit in the recess, the liner being chosen to approximately conform to the initial shape of the recess when inserted therein;
inserting a bearing member into the recess through the open end such that the liner is positioned inbetween the surfaces of the bearing member and recess;
swaging the bearing housing in such a way that the recess and liner each conform to the shape of the bearing member and the area of the open end of the recess is reduced in size to prevent removal of the bearing member from the housing during normal use of the bearing.

26. A method according to claim 25, wherein the bearing member is the ball portion of a given ballpin.

27. A method according to claim 25, wherein the conforming section is shaped such that when the bearing member is inserted into the recess, there exists a clearance gap between the bearing member and the conforming section immediately adjacent the transition boundary, the clearance gap being larger than any gap between the cup section and the bearing member, whereby after deformation of the bearing housing, the conforming section conforms closely to the ball portion immediately adjacent the transition boundary.

28. A method according to claim 25, wherein the inner surface of the conforming section is concave.

29. A method according to claim 28, wherein the cup section is in the form of a segment of a sphere, radius R.

30. A method according to claim 29, wherein the radius of arc of the conforming section is greater than R.

31. A method according to claim 30, wherein the radius of arc of the conforming section is at least double R.

32. A bearing comprising a bearing housing incorporating a recess formed therein, a bearing member seated within the recess, and a pre-formed, self-lubricating, self-supporting, continuous liner positioned inbetween the bearing member and the bearing housing, wherein the recess and liner conform closely to the shape of the bearing member in such a way as to prevent removal of the bearing member from the recess.

33. A bearing according to claim 32, wherein the bearing member is a ballpin.

34.-38. (canceled)

39. A method according to claim 5, wherein the lubricating material is PTFE.

40. A method according to claim 7, wherein the mesh is formed from phosphor bronze.

41. A method according to claim 7, wherein the mesh is formed from stainless steel.
